(19) United States
(12) Patent Application Publication
(10) Pub. No.: US 2006/0187889 A1
(43) Pub. Date: Aug. 24, 2006

(54) System to mine information from data generated by Location Enabled Devices

(75) Inventors: Chand Mehta, Campbell, CA (US); Jitendra Dhawas, Santa Clara, CA (US)

Correspondence Address: CHAND MEHTA, 299 UNION AVE #D-1079, CAMPBELL, CA, 99008, US

(73) Assignee: Mr. Chand Mehta, Campbell, CA (US)

(21) Appl. No.: 10/906,441

(22) Filed: Feb. 19, 2005

(51) Int. Cl. H04Q 7/24

(52) U.S. Cl. 370/338; 370/252

(57) ABSTRACT

The present invention describes a method and system of extracting useful information from the location data record of a Wireless Device, available at Position Determination System (PDS) in a wireless network such as CDMA, GSM, UMTS, WiFi and other current and future networks. The location data may include Time, Longitude, Latitude, Altitude, Velocity and Direction of the Object. The information extracted and derived from this data is broadly related to, but not limited to, 1) Vehicular Traffic information 2) Demographic behavioral and trending information. The current invention is also envisioning a system and protocol of conveying this information to other systems that can use this information along with information form other sources, if any, for providing additional services. As a corollary, the invention is also proposing Location Enabled Remote Sensor System.

### FIELD OF INVENTION

The present invention describes a method and system of extracting useful information from the location data record of a wireless device, available at Position Determination System (PDS) in a wireless network such as CDMA, GSM, UMTS, Wi-Fi and other current and future networks. The location data may include Time, Longitude, Latitude, Altitude, Velocity and Direction of the Object. The information extracted and derived from this data is broadly related to, but not limited to:
Vehicular Traffic information
Demographic behavioral and trending information.

The current invention also describes a system and protocol of conveying this information to other systems that can use this information along with data form other sources, if any, for providing additional services.

### BACKGROUND

Many techniques are currently available to gather vehicular traffic data. The data is then used to computationally estimate travel time and path from start to destination location. The data is also used to actuate traffic control device, detect congestion, queuing as well as crashes and breakdowns on the roadway. This data is also used for highway planning and maintenance by Department of Transportation, Federal Highway Administration and other public agencies. The performance of such a collective systems is based on reliability and accuracy of the collected vehicular traffic data.

Various types of loop detectors have been used for several years and are the backbone of the traffic management and data collection systems today. Inductive Loop Detector (ILD) is the most common technology used on freeways and arterial roadways to collect real-time data on vehicle presence, vehicle speed and vehicle length. Another technique utilizes the microwave radars to collect traffic information on the highways and other roadways.

Yet another method, which is not in extensive use, requires use of GPS enabled vehicles that are driven around the free ways and their position and speed is reported back to the central server for computation.

One of the major disadvantages of the existing methods is scalability. The loop detector and the microwave radar techniques require deployment of expensive special purpose devices for gathering the traffic information and then relaying this information back to the central server for archiving and processing. Similarly, additional vehicles and drivers are need for the method using GPS enabled vehicles.

Also, the current method does not provide a way to extract or derive Demographic behavioral and trending information.

### SUMMARY OF INVENTION

One of the goals of current invention is to provide globally scalable and cost effective method of detecting vehicular traffic information. The information can then be provided to other systems to provide numerous useful services.

The use of next generation wireless communication and data services is increasing. Location based services are gaining increasing popularity both in the US and internationally. All the major network providers are deploying infrastructure to facilitate calculation of location of a wireless device. At the minimum, the location data generally include Time, Longitude, Latitude, Altitude, Velocity and Direction of the object carrying a wireless device. It can also include additional data to specifically identify a wireless device. Depending on the type of network and services provided, the estimated location of a wireless device can have accuracy of as low as, 5 m to 500 m.

It is noted that the network service provider also keeps records of the location estimation data for a particular device for billing and other purposes. The current invention is proposing to use this raw data to extract and derive useful information.

The current invention is proposing to extracted information that is broadly related to:

(1) Vehicular traffic information

(2) Demographic behavioral and trending information

The current invention is also proposing a method to deliver the processed information to the other systems that can use this information to improve the performance of their services.

### BRIEF DESCRIPTION OF DRAWING

FIG. 1: Depicts a block diagram of reference wireless network and Position Determination System (PDS). Unit A, Wireless Device, is used to mean any location-enabled device that can estimate its location or facilitate estimation of its location. It is able to communicate with Position Determination System using the mechanism provided by the network. The term Object is occasionally used in this document to mean any vehicle, person or physical entity that is carrying or hosting a Wireless Device.

FIG. 2: Depicts the block diagram of Position Information Processing and Presentation System proposed by current invention. The details are described in the next section.

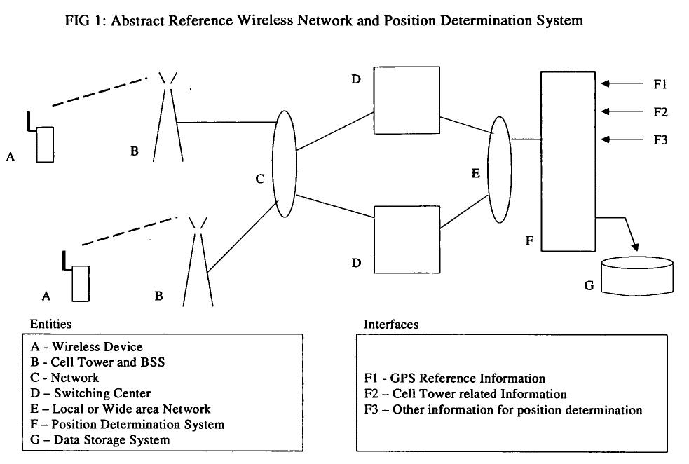

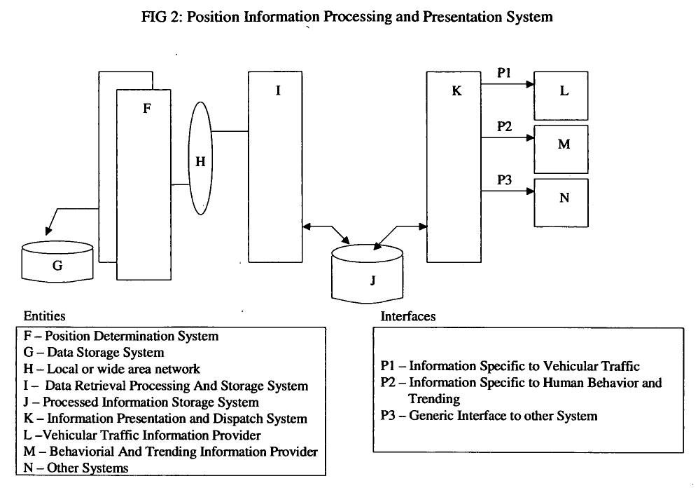

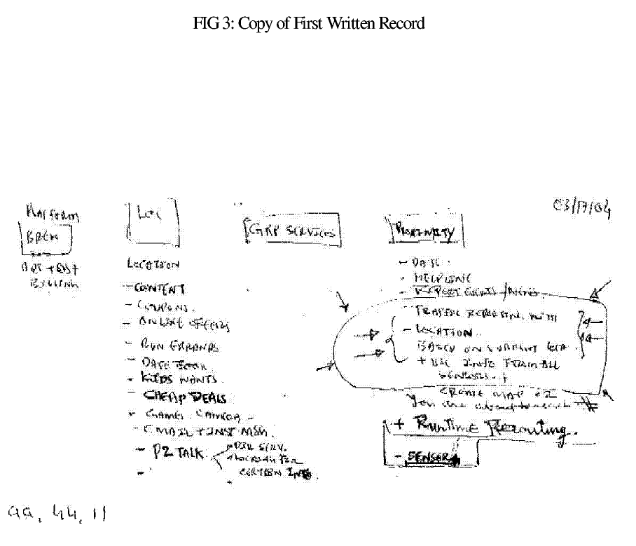

### DESCRIPTION OF INVENTION

One of the goals of current invention is to provide globally scalable and cost effective method of detecting vehicular traffic information. The information can then be provided to other systems to provide numerous useful services. The subsequent description is divided in to the following parts.

(1) Data Retrieval from various PDS in a wireless network

(2) Processing and storage of normalized information

(3) Information presentation and dispatch

Data Retrieval from Various PDS in a Wireless Network

In a wireless network, PDS and its equivalent, records a result of location estimate for a given wireless device. The current invention is proposing that the network providers allow access to this data. A standardize protocol to transfer this information to Unit I (Data Retrieval Processing and Storage System) can be agreed upon which will provide, at the minimum, Time, Longitude, Latitude, Altitude, Velocity. In order to preserve privacy and identity of the bearer of the wireless device, pseudo identification can be provided instead of real identification of the wireless device. Those skilled in the art will appreciate that numerous methods can be used to transfer this raw data from PDS to Unit I.

Processing and Storage of Normalized Information

Once the data is transferred to Unit I, either in real time or near real time, it can apply commonly known and new algorithms to aggregate the data and computationally derive information related to vehicular speed on a particular segment of a road. When a statistically significant set of such data is available, on one or more segment of road or roads in a region, a complete real time traffic model can be generated. The model of real time vehicular traffic information can be stored in Unit J (Processed Information Storage System).

When enough raw data is available, the Pseudo Identifier can be used to generate a collective model of individual and group behavior of Objects in a particular region. The following set of information can be derived from this raw data:

(1) Time to reach work from home

(2) Distance traveled from work to home

(3) Percentage of people traveling outside of region for work

(4) Percentage of people traveling to the region for work

(5) Popular shopping mall in the region

(6) Peak hours at the shopping malls or grocery stores in a region

The word “work” above is referenced to mean any location that individual spends time at during the normal business hour. Those skilled in the art will appreciate that numerous current and historic information can be extracted and derived from this data.

Information Presentation and Dispatch

Unit K (Information Presentation and Dispatch System) provides the interface to other systems that can use the information stored in Unit J. It is envisioned to provide the following three interfaces:

(1) P1—Vehicular Traffic Information Dispatch

This interface provided means to transfer information specific to vehicular traffic model. The information could relate to both real time and historic vehicular traffic models. The interfacing system Unit L (Vehicular Traffic Information Provider) can use this information along with data from other sources like ILD, Microwave Radar System, and Emergency Response System to provide complete and accurate coverage of vehicular traffic in a region. These systems can also use this information to actuate and control traffic lights and meters to improve flow of traffic.
   (2) P2—Demographic Behavioral and Trending Information Dispatch
This interface provides means to transfer information specific to behavioral and trending information. The interfacing system Unit M (Behavioral and Trending Information Provider) can combine this information with additional sources like market surveys, census information to devise improved marketing and advertisement tools.
   (3) P3—Generic Information Dispatch
This interface provides means to transfer all other useful information that is not covered by the interface P1 and P2. Government and other public safety organization may request tracking of a particular Pseudo Identifier when they have access to the actual identifier to a Pseudo identifier.

In order to facilitate generation of location estimation data, the current invention is also proposing a software application that resides on a wireless device. It does the following:
(1) Performs wireless device based location estimation using the available mechanism in its wireless network.
(2) Process the information locally and compute a traffic model for itself.
(3) At a predetermined interval, it initiates a process of transferring this information to the Unit I
   Various algorithms can be used to achieve the goal of item b above. The purpose of this software application is to distribute processing and avoid sending large amount of data to the central system Unit I. Depending on the configuration, it also has the ability to filter unwanted data, for e.g. when Object is stationary or walking on a street.

As a corollary, the current invention is also proposing a Location Enabled Remote Sensor System. In this system any type of sensor can be equipped with Location Estimation capability using GPS or the method provided by wireless network providers as described above. The sensor can then append location data to the information it normally sense. This combined information can then optionally be sent to a Central System for further analysis and storage, using private or public network. The Central System can then accordingly actuate and control the related system components. The Central System can also create a real time model of all the Sensors and present it visually on a digital map.

While the present invention has been described with respect to a single preferred embodiment, those skilled in the art will appreciate numerous modifications and variations there from. It is intended that the appended claims cover all such modifications and variations as fall within the true spirit and scope of the present invention.

### REFERENCE CITED

Reference Cited

| U.S. Pat. No. | Date | Inventor | US Class |
|---|---|---|---|
| 5,539,645 | July 1996 | Mandhyan; Indur B. | 701/119 |
| 5,699,056 | December 1997 | Yoshida; Masato | 340/905 |
| 6,236,933 | May 2001 | Lang; Brook | 701/117 |
| 6,401,027 | June 2002 | Xu; Yiwen | 701/117 |
| 6,427,113 | July 2002 | Rahman; Mohammed | 701/117 |
| | | Rezaur | |
| 6,480,783 | November 2002 | Myr; David | 701/117 |

First Written Record

The invention was first conceived and recorded on Mar. 17, 2004. A scan of the paper record is provided as FIG. 3.

What is claimed is:

1. System for archiving useful data acquired by Position Determination System (PDS) in a Location enabled wireless telecommunication network. The data may include at the minimum Time, Longitude, Latitude, Altitude, Velocity and Direction of the Object carrying the Wireless Device.
Additional information can be saved to specifically identify a wireless device.
Location Information may be calculated using any of the known method like GPS, A-GPS, AFLT, EFLT, RSSI, Cell Sector or any other means.
The Object can be a person, vehicle or any other physical entity carrying or hosting the wireless device. The wireless device can be any location enabled device capable of operating with one or more types of wireless network like CDMA, GSM, UMTS, Wi-Fi and others. The wireless device can also be any other location enabled device or system that is capable of relaying or transmitting the location information back to the central server system either over public wireless network or any other type of network.

2. As per claim 1, System for processing and mining the data to predict real time vehicular traffic information.

3. As per claim 1, System for processing and mining the data to extract historical vehicular traffic data on a given section of a road on a given time of the day.

4. As per claim 1, System and protocols for conveying the updated vehicular traffic information to other networked systems and apparatus. The information could be provided in real time or near real time depending on the needs of the interfacing System.

5. As per claim 1, System and protocols to interface with other emergency response systems of Police, DoT, Weather Forecast, Public Events and others. System to process this additional information to predict vehicular traffic information.

6. As per claim 1, System for processing and mining the data to extract behavioral and trending information of Objects in a particular region or locality.

7. As per claim 1, System and protocols for conveying the updated behavioral information to other networked systems and apparatus.

8. Also claimed is a generic system for collecting, transmitting, archiving, processing and presenting the real time and near real time information acquired by location enabled sensor devices. The sensor devices could be any type of sensor or gauge that can sense relevant information and make it more useful by annotating time and location information to it.

9. Also claimed is a generic software application running on a wireless device that does specified number of location calculation at a specified time interval. It then relays or transmit the raw or processed information back to the System as per claim 1.
